(19) United States
(12) Patent Application Publication
(10) Pub. No.: US 2004/0027720 A1
(43) Pub. Date: Feb. 12, 2004

(54) Disk cartridge

(75) Inventors: Fumihito Imai, Odawara-shi (JP); Hideaki Shiga, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/629,712

(22) Filed: Jul. 30, 2003

(30) Foreign Application Priority Data
Aug. 6, 2002 (JP) 228255/2002

(51) Int. Cl. G11B 23/03

(52) U.S. Cl. 360/133

(57) ABSTRACT

A disk cartridge comprising a recording disk medium and a housing that rotatably houses the disk medium. The housing is made up of an upper shell and a lower shell. The upper shell and the lower shell are fastened together with fastening members that are easily removable.

### BACKGROUND OF THE INVENTION

1. Field of the Invention

The present invention relates to a small disk cartridge in which a recording disk medium having an outside diameter of 2 inches or less is rotatably supported within a housing made up of upper and lower metal shells, and more particularly to the assembly structure of the upper and lower shells.

2. Description of the Related Art

In mobile equipment such as digital cameras and the like, a very small disk cartridge, called “clik!™” such as that schematically shown in FIG. 10, is being used as a recording medium. This disk cartridge 1 is 50 mm in width, 55 mm in depth, and 1.95 mm in thickness. It has a housing, which is constructed of a resin frame 2 and upper and lower metal shells (stainless steel of 0.2 mm in thickness) 3, 4. The housing rotatably supports a magnetic disk having a diameter of 1.8 inches (about 45.7 mm) which has a recording capacity of 40 MB, and is equipped with a U-shaped opening 6 through which a magnetic head is positioned over a recording surface of the magnetic disk, and a rotary shutter 7 that covers the U-shaped opening 6 when read and write operations are not performed. The upper and lower shells 3, 4 are laser welded at 10 or more positions with the outer circumferences engaged with each other.

The structure of the welded upper and lower metal shells 3 and 4, however, has the following problems: (1) an expensive, special machine such as a laser welding machine is required and the upper and lower shells 3, 4 need to be precisely positioned so they are aligned with each other; (2) paper or sputter dust occurs at the time of welding, adheres to a recording medium, and has an adverse influence on read and write operations, and also contaminates assembly space (which requires a class 100 to 1000 clean room); and (3) when disassembling the welded upper and lower shells 3 and 4 for recycling or collection of classified refuse, the disassembly of them is fairly difficult and time-consuming, and since they are destroyed by disassembly, it is impossible to recycle them.

### SUMMARY OF THE INVENTION

The present invention has been made in view of the circumstances described above. Accordingly, it is the object of the present invention to provide an assembly structure of upper and lower shells which has fixed all of the problems described above.

To achieve this end and in accordance with the present invention, there is provided a disk cartridge comprising a recording disk medium having a diameter of 2 inches or less, a housing, and a shutter. The housing comprises upper and lower metal shells and has a head opening through which a record/playback head is positioned over a recording surface of the disk medium. Within the housing, the disk medium is rotatably supported. The shutter is used for covering the head opening when read and write operations are not performed. The upper shell and the lower shell are fastened together with fastening members that are easily removable.

In one preferred form of the present invention, at least one of the upper shell and the lower shell is equipped with bosses that have an aperture and a step portion, and each of the fastening members has a plurality of elastic pieces that have engagement portions that snap-engage the step portion when pushed in the aperture of the boss. The fastening members may be formed integrally with either the upper shell or the lower shell, or may be members separate from the upper and lower shells.

In another preferred form of the present invention, each of the fastening members comprises a staple. The material of the staple may be metal or resin.

In still another preferred form of the present invention, each of the fastening members comprises a member that is caulked with heat. The member that is caulked with heat can be formed from a fastening boss of thermoplastic resin provided on either the upper shell or the lower shell by outsert molding. After the fastening bosses on one shell have been inserted in apertures formed in another shell, they are caulked with heat. Each of the fastening bosses may be a discrete member that is caulked with heat.

According to the present invention, the housing of the disk cartridge is constructed such that the upper and lower shells are fastened together with fastening members that are easily removable. Thus, an expensive laser machine such as a laser welding machine is not required and the disk cartridge can be easily and precisely assembled. In addition, there is no possibility that paper or sputter dust, which can contaminate an assembly environment and have an adverse influence on read and write operations, will be generated during assembly. Furthermore, when disassembling the upper and lower shells for recycling or collection of classified refuse, the disassembly of them is easy, and recycling of them is possible.

### BRIEF DESCRIPTION OF THE DRAWINGS

The present invention will be described in further detail with reference to the accompanying drawings wherein:

FIG. 1 is a perspective view showing a disk cartridge constructed in accordance with a first embodiment of the present invention;

FIG. 2 is a sectional view showing the principal part of the disk cartridge shown in FIG. 1;

FIG. 3 is a perspective view of the fastening member shown in FIG. 2;

FIG. 4 is a view similar to FIG.2 showing an alteration of the fastening member shown in FIG. 3;

FIG. 5 is a perspective view showing a disk cartridge constructed in accordance with a second embodiment of the present invention;

FIG. 6 is a sectional view showing the principal part of the disk cartridge shown in FIG. 5;

FIG. 7 is an exploded perspective view showing a disk cartridge constructed in accordance with a third embodiment of the present invention;

FIG. 8 is a sectional view showing the principal part of the disk cartridge shown in FIG. 7;

FIGS. 9A and 9B are sectional views showing the principal part of a disk cartridge constructed in accordance with a fourth embodiment of the present invention; and

FIG. 10 is a perspective view showing a conventional disk cartridge.

### DESCRIPTION OF THE PREFERRED EMBODIMENTS

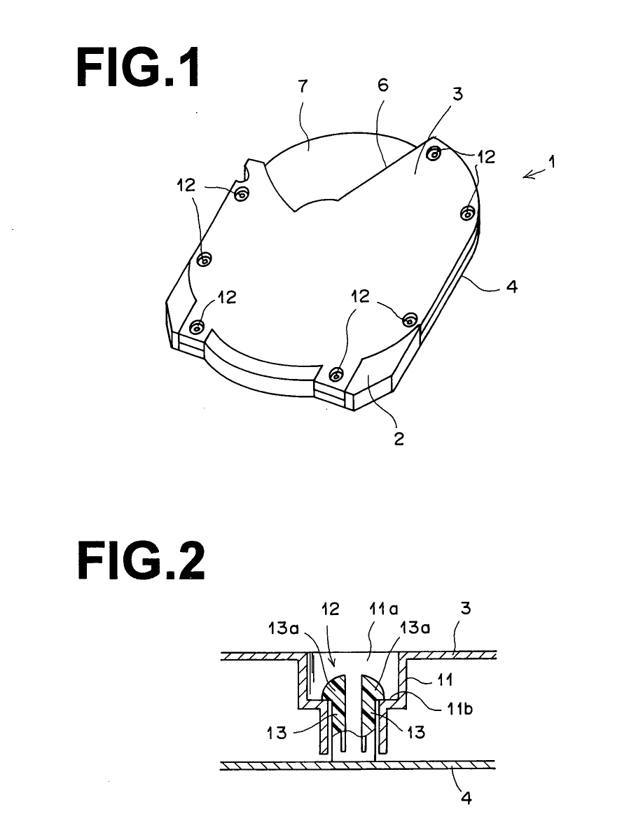

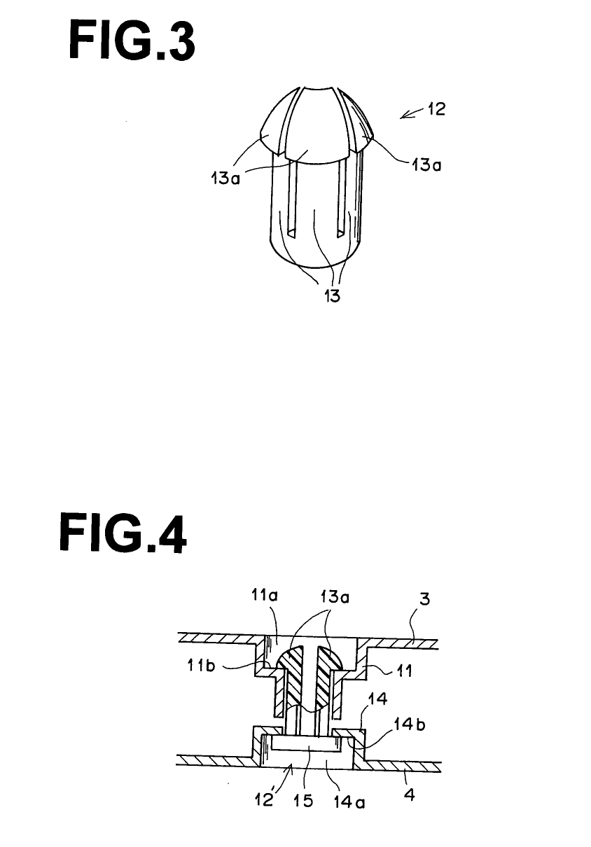

Referring now to FIGS. 1 through 3, there is shown a disk cartridge constructed in accordance with a first embodiment of the present invention. The disk cartridge 1 has a housing, which is constructed of a resin frame 2 and upper and lower metal shells 3, 4. The housing rotatably supports a magnetic disk having a diameter of 1.8 inches (about 45.7 mm) which has a recording capacity of 40 MB, and is equipped with a U-shaped opening 6 through which a magnetic head is positioned over a recording surface of the magnetic disk, and a rotary shutter 7 that covers the U-shaped opening 6 when read and write operations are not performed. The upper and lower shells 3, 4 are fastened together by 7 (seven) fastening members 12, which are constructed as shown in FIGS. 2 and 3.

The upper shell 3 is provided with 7 (seven) bosses 11, each of which has a boss aperture 11a and a step portion 11b. The lower shell 4 is provided with the above-described fastening members 12, which are formed concentrically with the boss apertures 11a of the upper shell 3 by insert molding of metal and PBT resin. Each of the fastening members 12 is equipped with 4 (four) elastic pieces 13, and each elastic piece 13 has an engagement portion 13a. If the fastening members 12 are pushed in the apertures 11a of the bosses 11 of the upper shell 3 from below, the engagement portions 13a are snap-engaged with the step portions 11b of the apertures 11a and therefore the upper and lower shells 3, 4 are firmly fastened together.

Although not shown, the frame 2 is provided with through apertures for escaping the above-described bosses 11. Also, instead of employing the fastening members 12 integral with the upper shell 3 or lower shell 4, fastening members 12′ separate from the upper and lower shells 3, 4 may be employed as shown in FIG. 4. Each of the fastening members 12′ has a head portion 15 larger than a stem portion, while the lower shell 4 is provided with lower bosses 14. The lower bosses 14 are formed concentrically with the upper bosses 11. Each of the lower bosses 14 has an aperture 14a and a step portion 14b. If the fastening members 12′ are pushed in the apertures 14a through the bottom surface of the lower shell 4, then the head portions 15 abut the step portions 14b, the engagement portions 13a are snap-engaged with the step portions 11b of the apertures 11a of the upper shell 3, and the upper shell 3 and lower shell 4 are firmly fastened together.

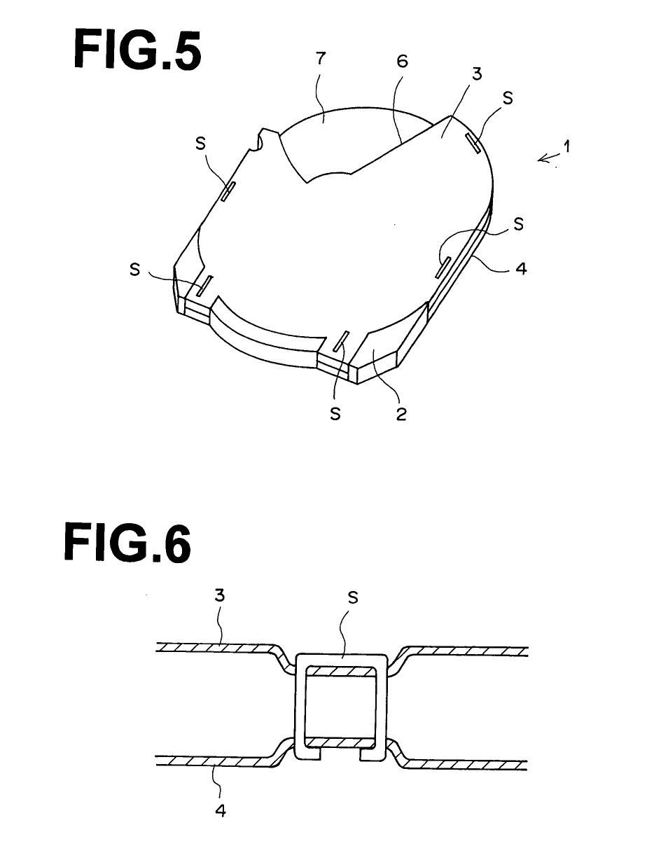

Referring to FIG. 5, there is shown a disk cartridge constructed in accordance with a second embodiment of the present invention. In this embodiment, upper and lower shells 3, 4 are firmly fastened with staples S, as shown in FIG. 6.

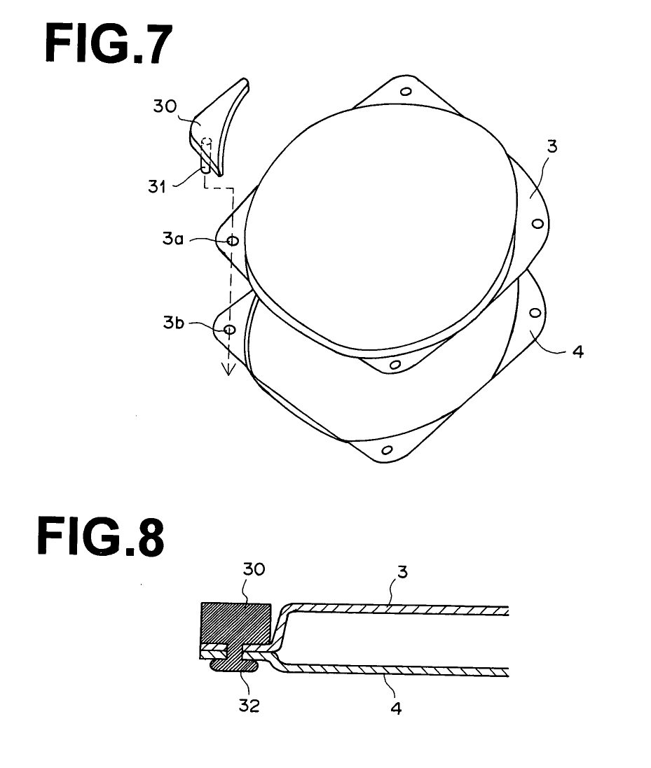

Referring to FIGS. 7 and 8, there is shown a disk cartridge constructed in accordance with a third embodiment of the present invention. As shown in FIG. 7, a fastening member 30 of thermoplastic resin is equipped with a fastening boss 31. The fastening boss 31 is inserted through apertures 3a, 4a of upper and lower shells 3, 4, and then it is caulked with heat, as indicated at reference numeral 32 in FIG. 8. In this way, the upper and lower shells 3, 4 are firmly fastened together.

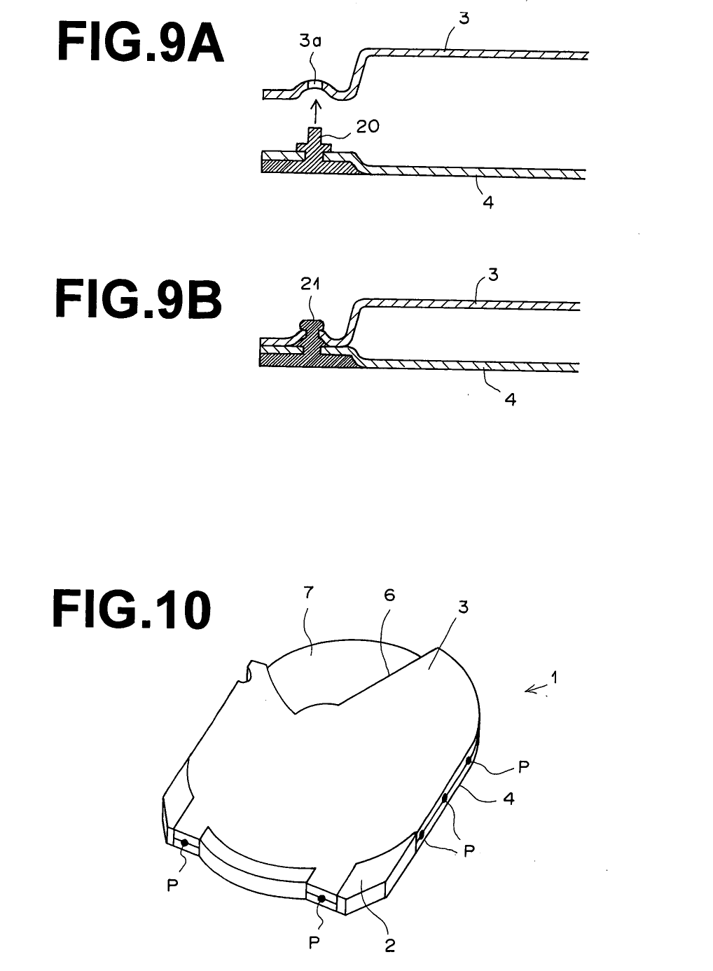

Referring to FIGS. 9A and 9B, there is depicted a disk cartridge constructed in accordance with a fourth embodiment of the present invention. Instead of employing the fastening member 30 that is a discrete body, a fastening boss 20 of thermoplastic resin may be provided on a lower shell 4 by outsert molding. After the fastening boss 20 is inserted through an aperture 3a formed in an upper shell 3, it is caulked with heat, as indicated at reference numeral 21 in FIG. 9B, whereby the upper and lower shells 3,4 are firmly fastened.

It is apparent that the above-described embodiments are all excellent in assembly and disassembly, do not contaminate the assembly environment, and have no adverse influence on read and write operations.

While the present invention has been described with reference to the preferred embodiments thereof, the invention is not to be limited to the details given herein, but may be modified within the scope of the invention hereinafter claimed.

What is claimed is:

1. A disk cartridge comprising:
a recording disk medium of diameter 2 inch or less;
a housing which comprises upper and lower metal shells and has a head opening through which a record/playback head is positioned over a recording surface of said disk medium, and in which said disk medium is rotatably supported; and
a shutter for covering said head opening when read and write operations are not performed;
wherein said upper shell and said lower shell are fastened together with fastening members that are easily removable.

2. The disk cartridge as set forth in claim 1, wherein
at least one of said upper shell and said lower shell is equipped with bosses that have an aperture and a step portion, and
each of said fastening members has a plurality of elastic pieces that have engagement portions that snap-engage said step portion when pushed in the aperture of said boss.

3. The disk cartridge as set forth in claim 1, wherein each of said fastening members comprises a staple.

4. The disk cartridge as set forth in claim 1, wherein each of said fastening members comprises a member that is caulked with heat.

5. The disk cartridge as set forth in claim 4, wherein said member that is caulked with heat comprises a fastening boss of thermoplastic resin provided on either said upper shell or said lower shell by outsert molding.
